(19) United States
(12) Patent Application Publication
(10) Pub. No.: US 2026/0343313 A1
(43) Pub. Date: Oct. 29, 2026

(54) HANDLING TL CONTAINER FOR GNB SUPPORTING TSN NETWORK

(71) Applicant: Telefonaktiebolaget LM Ericsson (publ), Stockholm (SE)

(72) Inventors: Nianshan SHI, JÄRFÄLLA (SE); György MIKLÓS, PILISBOROSJENÖ (HU)

(73) Assignee: Telefonaktiebolaget LM Ericsson (publ), Stockholm (SE)

(21) Appl. No.: 19/483,576

(22) PCT Filed: May 8, 2024
(86) PCT No.: PCT/SE2024/050445

§ 371 Date: Nov. 11, 2025

Related U.S. Application Data
(60) Provisional application No. 63/465,809, filed on May 11, 2023.

(51) Int. Cl. H04W 28/02; H04L 41/342; H04W 76/10

(52) U.S. Cl. CPC H04W 28/0268; H04L 41/342; H04W 76/10

(57) ABSTRACT

A method performed by a radio access network node includes receiving, from a network function in a core network, a message including a talker/listener (TL) interface configuration for a quality of service (QoS) flow over a transport network between the radio access network node and the core network, and applying the TL interface configuration to the QoS flow.

### TECHNICAL FIELD

The present disclosure relates to wireless communication networks, and in particular to support for time sensitive networking in wireless communication networks.

### BACKGROUND

The fifth generation of wireless communication technology (5G) is positioned to provide much wider range of services, including mission critical services, such as Critical Machine Type of Communication (C-MTC) services. The use cases for C-MTC include numerous applications, most of which can be characterized by low latency and high reliability. Time Sensitive Communication (TSC) refers to a communication service that supports deterministic communication (i.e. which ensures a maximum delay) and/or isochronous communication with high reliability and availability. TSC provides packet transport with quality of service (QoS) characteristics, such as bounds on latency, loss, and reliability, where end systems and relay/transmit nodes may or may not be strictly synchronized.

The Time-Sensitive Networking (TSN) Task Group of IEEE 802.1 provides a standardized solution for satisfying low latency and high reliability requirements in fixed Ethernet networks. 3GPP has defined an integration mechanism into TSN networks, so that 3GPP networks can also act as virtual bridges (e.g., a 5GS bridge) on a per user plane function (UPF) granularity. The 3GPP work focuses on a fully centralized network model scenario in which a Centralized Network Controller (CNC) provides the configuration for the TSN bridges. In the control plane, a TSN application function (AF) provides a signaling interface between the CNC controlling the TSN network and the 3GPP network functions. In the user plane, device-side TSN translator (DS-TT) ports correspond to logical ports of the 5G system bridge on the device side, and network-side TSN translator (NW-TT) ports correspond to logical ports of the 5G system bridge on the network side.

FIG. 1 illustrates a system architecture including a radio access network (RAN) serving a user equipment (UE), along with various network functions of a core network (CN). A transport network provides communication services between the RAN and the user plane function (UPF) in the CN. The transport network is configured by a transport controller. The NW-TT in the UPF provides an interface to a Data Network.

The 5GS bridge provides the delay between its logical ports. This information is provided from the TSN AF to the CNC. The delay is set based on pre-configuration in the TSN AF, which sets the delay between the UE and the UPF. Additionally, the TSN AF also considers the UE-DS-TT residence time within the terminal device that is reported to the TSN AF. The pre-configuration is based on the network operator's expected maximum delay that can be provided within the system considering the delay in the radio access network (RAN), and in the CN, including the delay spent within the transport network between RAN and the UPF.

In 3GPP Release 17, the 5GS architecture was generalized, and the system can also support delay sensitive traffic for IP flows in addition to Ethernet traffic, based on AF requirements. In 3GPP Release 18, 5GS integration with Deterministic Networking (DetNet) for IP was defined. Also for these additional scenarios, the use of TSN transport helps to fulfill the delay requirements.

In the current system architecture, the transport network that provides connectivity between the RAN and the CN is considered logically separate from the 3GPP entities, and there is no explicit signaling between the two domains. The transport network can be realized and deployed separately from the 3GPP entities. It is up to the deployment to decide which technology to use in the transport network which can ensure the required delays within the network. It may be possible to apply a TSN network also in the transport domain, or a DetNet network in the transport domain to make sure that the delay targets are met. However, in the current network architecture there is no control signaling or other ways of explicit dynamic coordination between the 3GPP entities and the transport domain.

### SUMMARY

Some embodiments described herein provide solutions to support the end-to-end performance of time sensitive traffic flow, including the transport network during setup, modification and handover procedures.

In particular, some embodiments provide a method performed by a radio access network node. The method includes receiving, from a network function in a core network, a message including a talker/listener (TL) interface configuration for a QoS flow over a transport network between the radio access network node and the core network, and applying the TL interface configuration to the QoS flow.

The message may include a TL container transfer message that includes a TL container. In some embodiments, the message includes a TL set-request or a TL get-request.

In response to the message, the QoS flow may be set up or modified to be a TSN QoS flow having an individual transport network layer (TNL) internet protocol (IP) tunnel.

The method may further include transmitting a TL container response to the network function in response to the message. The TL container response may include a TL set-response or a TL get-response.

The TSN QoS flow may have an associated QoS flow indicator (QFI) and the TNL tunnel may be associated with the QFI. The message may include a QFI associated with the TL interface configuration.

The method may further include determining a failure of applying the TL interface configuration to the QoS flow, and in response to the failure of applying the TL interface configuration to the QoS flow, setting up the QoS flow as a normal, non-time sensitive networking, QoS flow.

The message may be a protocol data unit (PDU) session setup request or a PDU session modification request

The method may further include receiving a PDU session setup request identifying the QoS flow, and establishing a PDU session for the QoS flow in response to the PDU session setup request, wherein the message including the TL configuration is received after establishment of the PDU session.

Some embodiments provide a method performed by a radio access network node. The method includes receiving, from a network function in a core network, a PDU session setup request identifying a QoS flow over a transport network between the radio access network node and the core network, establishing a PDU session for the QoS flow in response to the PDU session setup request, receiving, from the network function, a message including a TL interface configuration for the QoS flow, and applying the TL interface configuration to the QoS flow.

The message including the TL configuration may be received after establishment of the PDU session.

The method may further include transmitting a TL container response to the network function in response to the message.

The TL container response may include a TL set-response or a TL get-response.

The method may further include providing user data and forwarding the user data to a host using the QoS flow.

Some embodiments provide a radio access network node that includes processing circuitry configured to perform any of the steps described above, and power supply circuitry configured to supply power to the processing circuitry.

Some embodiments provide a method performed by a network function in a core network. The method includes transmitting, to a radio access network (RAN) node, a message including a TL interface configuration for a QoS flow over a transport network between the radio access network node and the core network.

The message may include a TL container transfer message that includes a TL container. In some embodiments, message may include a TL set-request.

The message may indicate that the QoS flow is to be set up or modified to be a TSN QoS flow having an individual TNL IP tunnel.

The TSN QoS flow may have an associated QFI, and the TNL tunnel may be associated with the QFI.

The message may include a QFI associated with the TL interface configuration.

The method may further include receiving from the radio access network node an indication of failure of the radio access network node to set up or modify the QoS flow in response to the message.

The message may include a PDU session setup request

The method may further include transmitting a PDU session setup request to the radio access network node identifying the QoS flow, and establishing a PDU session for the QoS flow in response to the PDU session setup request, wherein the message including the TL configuration is transmitted after establishment of the PDU session.

Some embodiments provide a method performed by a network function of a core network. The method includes transmitting, to a RAN node, a PDU session setup request identifying a QoS flow over a transport network between the radio access network node and the core network, and upon establishment of a PDU session for the QoS flow in response to the PDU session setup request, transmitting, to the RAN node, a message including a TL interface configuration for the QoS flow.

The message may include a TL container transfer message that includes a TL container. In some embodiments, the message may include a TL set-request.

The message may indicate that the QoS flow is to be set up or modified to be a TSN QoS flow having an individual TNL IP tunnel.

The TSN QoS flow may have an associated QFI, and the TNL tunnel may be associated with the QFI.

The message may include a QFI associated with the TL interface configuration.

A core network node according to some embodiments includes processing circuitry configured to perform any of the above steps, and power supply circuitry configured to supply power to the processing circuitry.

### BRIEF DESCRIPTION OF THE DRAWINGS

FIG. 1 illustrates a system architecture including a radio access network serving a user equipment, along with various network functions of a core network.

FIG. 2 illustrates operations of a RAN node according to some embodiments.

FIG. 3 illustrates operations of a core network node according to some embodiments.

FIG. 4 illustrates a TL container transfer from a network function of a core network node to a RAN node according to some embodiments.

FIG. 5 illustrates a TL container transfer response from a RAN node to a network function according to some embodiments.

FIG. 6 illustrates a TL container transfer from a network function to a RAN node and a TL container transfer response from a RAN node to a network function according to some embodiments.

FIG. 7 illustrates operations of a network function of a core network node and a RAN node according to some embodiments.

FIG. 8 illustrates operations of a network function of a core network node and a RAN node according to further embodiments.

FIG. 9 illustrates operations of a RAN node according to some embodiments.

FIG. 10 illustrates operations of a network function of a core network node according to some embodiments.

FIG. 11 illustrates operations of a RAN node according to further embodiments.

FIG. 12 illustrates operations of a network of a core network node function according to further embodiments.

FIG. 13 illustrates an example of a communication system in accordance with some embodiments.

FIG. 14 illustrates a UE in accordance with some embodiments.

FIG. 15 illustrates a network node in accordance with some embodiments.

FIG. 16 illustrates a host in accordance with some embodiments.

FIG. 17 is a block diagram illustrating a virtualization environment in which functions implemented by some embodiments may be virtualized.

FIG. 18 shows a communication diagram of a host communicating via a network node with a UE over a partially wireless connection in accordance with some embodiments.

### DETAILED DESCRIPTION

As noted above, in wireless communication system such as a 3GPP-based system, a transport network provides communication services between the RAN and the UPF in the CN. The transport network has to ensure that delay requirements the end-to-end delay sensitive flows are met, without receiving explicit information about the flows themselves. Without concrete flow information, the transport network may not be able to provide as low delay bounds as would otherwise be possible. Also, it may be possible that the transport network is able to serve less traffic that meets the delay bounds. The transport network is not able to provide feedback about whether or not a specific flow can be served, and what should be the proper delay bound that the transport network can satisfy.

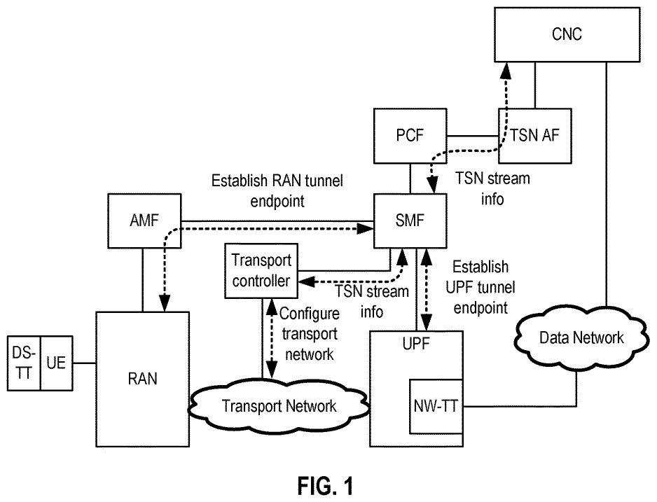

To help ensure that delay requirements for end-to-end delay sensitive flows are met, the 5GS supports the option of having separate IP addresses per QoS flow. This enables the transport network to identify flows that require delay sensitive treatment based on examination of the internet protocol (IP) header. That is important, as a typical TSN network can only use the Ethernet and IP header fields for stream identification, and is not able to look deeper into the packet to use the information in the GTP-U headers, such as a general packet radio service (GPRS) tunneling protocol (GTP) tunnel endpoint identifier (TEID) and QFI that would be required based on the existing 3GPP protocol. In the current 3GPP specification, when a PDU session is set up, only one transport network tunnel is set up per PDU session. In FIG. 1, this is performed in the operation denoted “Establish RAN tunnel endpoint” between the session management function (SMF) and the RAN.

Note that there are also more advanced TSN Ethernet mechanisms that might be also used as alternatives. One alternative is to use the so called “stream transformation functionality,” whereby additional Ethernet encapsulation is added at the RAN or UPF sides to the packets using VLANs, and the QoS flows could be identified based on the added VLAN headers.

For an NG-RAN node such as a gNB to support TSN, the gNB may support TL functionality, enabling it to act as a TSN Talker/Listener. Without such TL functionality, the Talker/Listener function would have to be placed at a neighboring TSN-enabled bridge. However, in that case, TSN support would not be possible between the gNB and the bridge. Having TL functionality in the gNB helps to support TSN transport over the entire interface. The TSN functionality needs to be configured between the Talker and Listener, including the endpoints and all the intermediate bridges. The TL container includes the configuration information to set up the Talker or Listener functionality.

There is currently no solution to support transfer of a TL configuration from the SMF to an NG-RAN node. Accordingly, some embodiments described herein provide solutions to support the end-to-end performance of time sensitive traffic flow, including the transport network during setup, modification and handover procedures.

In one proposed solution, two new procedures are defined over the NG application protocol (NGAP): one for TL Container Transfer and another for TL Container Transfer Response. In the message TL CONTAINER TRANSFER, the container transferred contains choices for different requests.

In one solution, a new procedure is defined over NGAP for a TL Container Transfer and a TL Container Transfer Response. The TL container indicates if the request is a get-request or a set-request.

In one solution, a new procedure is defined for the “TL get-request”, which is the request from 5GC to NG-RAN node, and the response from NG-RAN node to 5GC. One new procedure is defined to carry a “set-request” when the response back to SMF is not always needed.

In one solution, a TSN QoS flow is modified so it becomes a normal QoS flow, which means the individual TNL IP tunnel for the QoS flow is removed/released, and the QoS flow is moved to the PDU session tunnel. This procedure can be initiated either by NG-RAN node or the access and mobility management function (AMF).

In one solution, a normal QoS flow is modified so it becomes a TSN QoS flow with an individual TSN IP address, which means that an individual TNL IP tunnel for the QoS flow is set up for the QoS flow, and the QoS flow is removed from the PDU session tunnel. This procedure can be initiated either by NG-RAN node or AMF.

In one solution, a “set-request” is sent from a network function in the 5GS to NG-RAN node during QoS flow setup and modification with a TL interface configuration (“InterfaceConfiguration”) setting. The QFI and TNL tunnel association are updated by UPF and the NG-RAN node.

The solution may use non-UE associated signaling or may use UE associated signaling.

In one solution, how an NG-RAN node handles the situation when the TSN QoS flow cannot be set up is defined. For example, when the TSN QoS flow cannot be set up, the NG-RAN node may set up a normal QoS flow, or to fail the set up. The handling of the situation when the TSN QoS flow cannot be set up could also be determined based on indication from the 5GC, or by specification rules/configuration, or by gNB implementation.

Similarly, some embodiments specify how the NG-RAN node behaves during handover, e.g., whether a TSN QoS flow should be modified to a normal QoS flow, or not be included in the handover. The specification may be based on an indication from 5GC or a rule/configuration.

It is understood that the existing procedures can be modified to implement the above solutions.

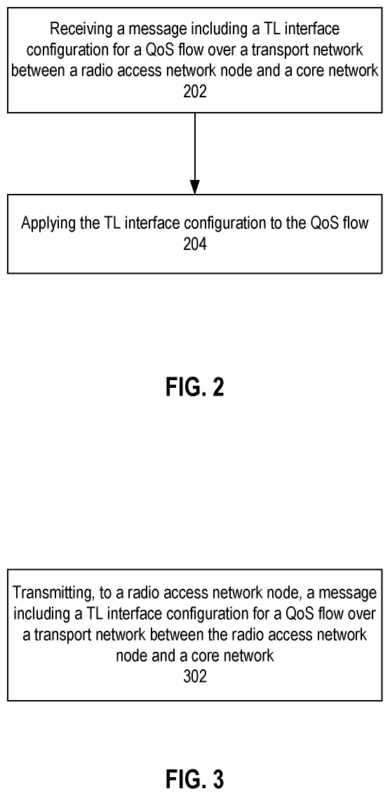

Operations of a radio access network node according to some embodiments are illustrated in FIG. 2. As shown therein, a method performed by a radio access network node includes receiving (block 202), from a network function in a core network, a message including a TL interface configuration for a QoS flow over a transport network between the radio access network node and the core network, and applying (block 204) the TL interface configuration to the QoS flow.

Operations of a core network node according to some embodiments are illustrated in FIG. 3. As shown therein, a method performed by a core network node includes transmitting (302), to a RAN node, a message including a talker/listener, TL, interface configuration for a quality of service, QoS, flow over a transport network between the RAN node and the core network.

Certain embodiments may provide one or more technical advantages. For example, some embodiments may enable interwork with a TSN network deployed in the transport network to be supported by NG-RAN node.

Some of the embodiments contemplated herein will now be described more fully with reference to the accompanying drawings. Embodiments are provided by way of example to convey the scope of the subject matter to those skilled in the art. Additional information may also be found in the document(s) provided in the Appendix.

In the present description, a time sensitive traffic flow that corresponds to a QoS flow is referred to as a “time sensitive QoS flow.” A TSN QoS flow is a QoS flow that requires an individual user plane IP address and requires the NG-RAN node to use the TSN. In some examples, the SMF communicates with an NG-RAN node via AMF. However, this is just an example, and the communication with the NG-RAN node could be by any CN entity that talks to NG-RAN node via a CN entity that has control plane connection to the NG-RAN node. It is understood that the existing procedures can be used for such communications.

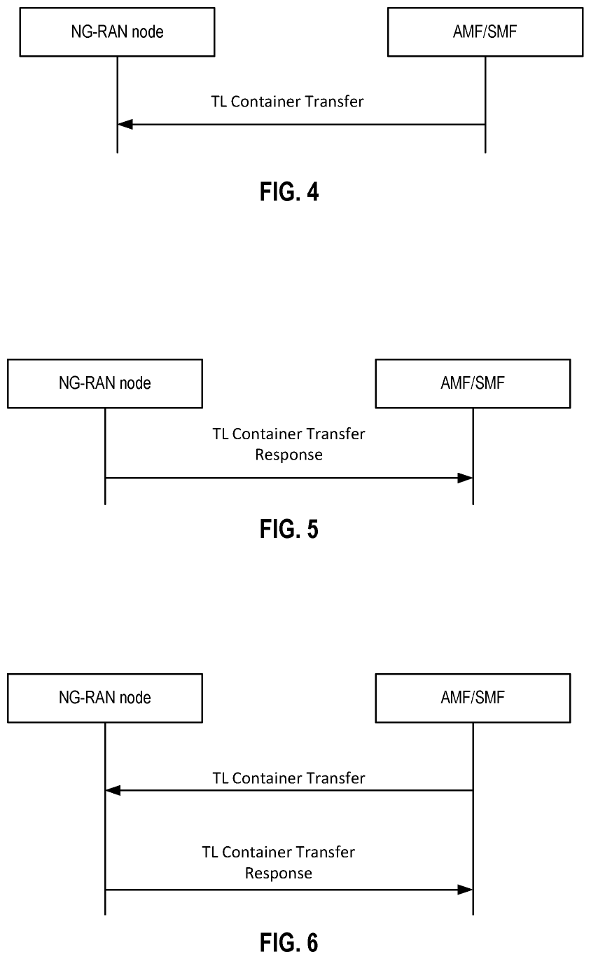

In one embodiment, referring to FIG. 4, a first procedure is defined to transfer a TL Container from the SMF (via AMF) to an NG-RAN node.

A second procedure is defined to transfer the response back from the NG-RAN node to the SMF (via AMF), as shown in FIG. 5. The transfer procedure can have a choice to transfer different access network (AN)-TL related commands as shown in Table 1, which shows an example of implementing TL container transfer in CHOICE TL Container Transfer. As shown in Table 1, a message type “CHOICE TL Container Transfer” may include a get-request having a get-Request-Container or a set-Request having a set-Request-Container.

TABLE 1
TL Container Transfer
9.x.y TL CONTAINER TRANSFER
Direction: AMF → NG-RAN node

| | | | | | | |
|---|---|---|---|---|---|---|
| | | | IE type and | Semantics | | Assigned |
| IE/Group Name | Presence | Range | reference | description | Criticality | Criticality |

| | | | | |
|---|---|---|---|---|
| Message Type | M | 9.3.1.1 | YES | ignore |
| CHOICE TL | M | | YES | reject |
| Container | | | | |
| Transfer | | | | |
| > get-Request | M | | — | — |
| >>get-Request- | M | FFS | — | — |
| Container | | | | |
| > set-Request | M | | — | — |
| >>set-Request- | M | FFS | — | — |
| Container | | | | |

Alternatively, the transfer procedures may be used to transfer one or more requests in the containers shown in Table 2, which illustrates an example of implementing one or more requests in a TL container transfer. As shown in Table 2, the TL Container Transfer message may have a message type of get-Request-Container or set-Request-Container.

TABLE 2
TL Container Transfer
9.x.y TL CONTAINER TRANSFER
Direction: AMF → NG-RAN node

| | | | | | | |
|---|---|---|---|---|---|---|
| | | | IE type and | Semantics | | Assigned |
| IE/Group Name | Presence | Range | reference | description | Criticality | Criticality |

| | | | | |
|---|---|---|---|---|
| Message Type | M | 9.3.1.1 | YES | ignore |
| get-Request | O | FFS | — | — |
| Container | | | | |
| set-Request | O | FFS | — | — |
| Container | | | | |

In one embodiment, an NG-RAN node, upon reception of the container transfer, will provide a response back to the SMF (via AMF) when such a response is needed. For example, for a get-request, the NG-RAN will provide the TSN QoS and tunnel information.

In one embodiment, the NG-RAN node performs an action requested by the SMF. For example, in response to a set-request, the NG-RAN node may send back a response indicating that the set-request is successful, or indicating when there is a failure in the set-request, such as when the QoS flow identifier (QFI) in an N3 tunnel associated with an InterfaceConfiguration is not found. This is illustrated in Tables 3A and 3B, which illustrate an example of a TL Container response from NG-RAN node to AMF.

TABLE 3A
TL Container Transfer Response
9.x.y + 1 TL CONTAINER TRANSFER RESPONSE
Direction: NG-RAN node → AMF

| | | | | | | |
|---|---|---|---|---|---|---|
| | | | IE type and | Semantics | | Assigned |
| IE/Group Name | Presence | Range | reference | description | Criticality | Criticality |

| | | | | |
|---|---|---|---|---|
| Message Type | M | 9.3.1.1 | YES | ignore |
| CHOICE TL | M | | YES | reject |
| Container Transfer | | | | |
| Response | | | | |
| > get-Request | M | | — | — |
| >>get-Request | M | FFS | — | — |
| Response | | | | |
| > set-Request | M | | — | — |
| >>set-Request | M | 9.x.y + 2 | — | — |
| Response | | | | |

TABLE 3B
set-Request Response
9.x.y + 2 set-Request Response

| | | | IE type and | |
|---|---|---|---|---|
| IE/Group Name | Presence | Range | reference | Semantics description |
| TSN Stream Set- | | 0 . . . 1 | | |
| request Response | | | | |
| List | | | | |
| > TSN Stream Set- | | 1 . . . <maxnoofQoSFlows> | | |
| request Response | | | | |
| Item | | | | |
| >>5QI | M | | INTEGER | Indicates the |
| | | | (0 . . . 255, . . .) | standardized or pre- |
| | | | | configured 5QI as |
| | | | | specified in TS 23.501 |
| | | | | [9]. |
| >>UP Tunnel | M | | | |
| Information | | | | |
| TSN Stream Set- | | 0 . . . 1 | | |
| request Failed List | | | | |
| > TSN Stream | | 1 . . . <maxnoofQoSFlows> | | |
| Set-request Failed | | | | |
| Item | | | | |
| >>5QI | M | | INTEGER | Indicates the |
| | | | (0 . . . 255, . . .) | standardized or pre- |
| | | | | configured 5QI as |
| | | | | specified in TS 23.501 |
| | | | | [9]. |
| >>UP Tunnel | M | | | |
| Information | | | | |
| >> cause | O | | | |

In one embodiment, referring to FIG. 6, a procedure is defined to transfer a TL container from SMF (via AMF) to an NG-RAN node, and to provide a feedback container from the NG-RAN node to the SMF (via AMF).

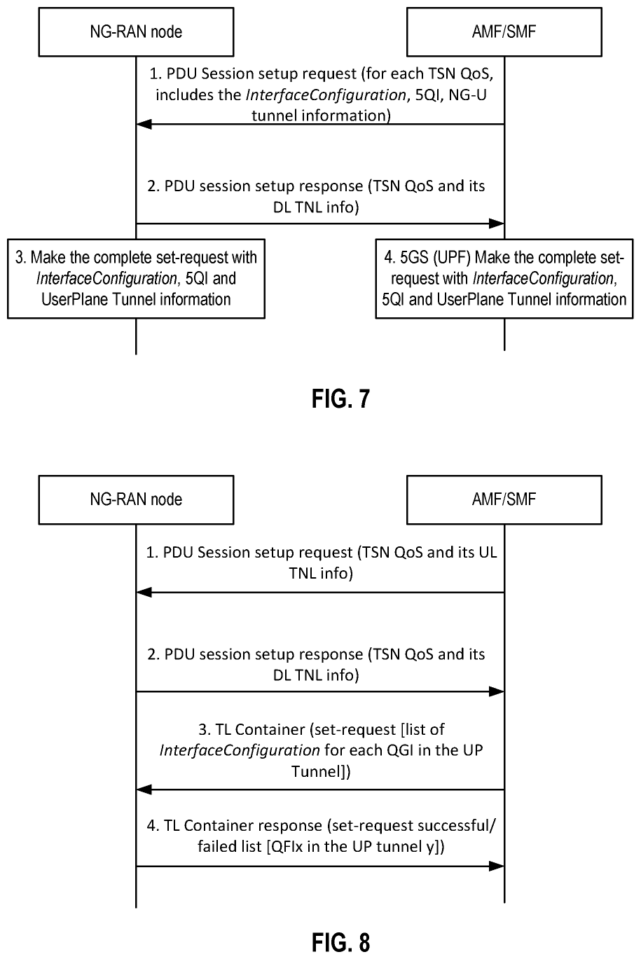

In one embodiment, a set-request is transferred from SMF (via AMF) in the QoS setup procedure (e.g., PDU session setup request). The QoS identifier, QFI, the InterfaceConfiguration and the NG-U Uplink TNL tunnel for the TSN QoS are provided to the NG-RAN node. When the TSN QoS is successfully set up, the NG-RAN node will provide the user plane interface (NG-U) downlink (DL) tunnel information for the TSN QoS back to the SMF (via AMF). The complete TL container with “InterfaceConfiguration” and the QFI/TNL association is sent to the transport layer by the UPF and the NG-RAN node. This is illustrated in FIG. 7.

Referring to FIG. 7, in step 1, the SMF sends (via AMF) a PDU session setup request. For each TSN QoS, this includes the InterfaceConfiguration, 5G QFI (5QI) and NG-U uplink (UL) tunnel information for the requested session. At step 2, the NG-RAN node responds with a PDU session setup response which includes the TSN QoS and downlink (DL) TNL information.

At step 3, the NG-RAN node makes the complete set-request with the InterfaceConfiguration, 5QI and user plane tunnel information.

At step 4, the SMF (via AMF) makes the complete set-request with the InterfaceConfiguration, 5QI and user plane tunnel information.

In one embodiment, the SMF sends (via AMF) a set-request in a TL container to the NG-RAN node after the QoS flow has been successfully set up. This may be performed via non-UE associated signaling, for multiple UEs and multiple TSN QoS flows. This is illustrated in FIG. 8.

Referring to FIG. 8, in step 1, SMF sends (via AMF) a PDU session setup request including the InterfaceConfiguration, 5QI and UL TNL tunnel information for the requested session. At step 2, the NG-RAN node responds with a PDU session setup response which includes the TSN QoS and DL TNL information.

At step 3, the SMF sends (via AMF) a TL Container request to the NG-RAN node including a set-request. The set-request includes a list of InterfaceConfiguration for each QFI in the UP tunnel.

At step 4, the NG-RAN node sends the SMF (via AMF) a TL Container response to the SMF (via AMF) containing an indication either that the set-request was successful or containing a list of QFI for which the set-request failed.

Alternatively, in some embodiments, the SMF may use UE associated signaling to update the RAN with the set-request, for example, in a UE or PDU session modification procedure.

In one embodiment, the NG-RAN node determines a “TSN QoS flow” (i.e., that an individual User Plan tunnel shall be setup for the given QoS) by an explicit indicator from SMF, or alternatively by checking the user plane (UP) Uplink Tunnel end point allocated by UPF for the given QoS, or by deriving the TSN QoS flow based on TSC assistance information (TSCAI) or 5QI.

In one embodiment, the SMF indicates to the NG-RAN node if the TSN QoS flow is allowed to be set up with an individual TNL tunnel, and/or with a “Mask-and-Match” option (in which no individual tunnel is needed). The NG-RAN node, when setting the TSN QoS flow with individual tunnel, may include the UP DL TNL information. Otherwise, it could setup as a normal QoS flow, but indicate support of “Mask-and-Match”. Alternatively, it could setup as a normal QoS flow without any TSN support. The SMF determines if the TL Container should be sent to RAN including the InterfaceConfiguration, QFI, and tunnel information.

In one embodiment, the SMF indicates to NG-RAN node that if the TSN QoS flow cannot be set up, it is allowed to be set up as a normal QoS flow. Similarly during handover, it may be determined whether the TSN QoS flow can be handed over to the target as a normal QoS flow, or should not be included in the handover. This may be specified or configured, or determined by the NG-RAN node based on the 5QI.

In one embodiment, it is specified that when a TSN QoS flow is set up, if the NG-RAN node does not include the UP DL TNL information for a given QoS, then 5GC understands that the TSN QoS is being setup as a normal QoS flow, and it should remove the UP UL TNL information and use the UP UL tunnel for the PDU session for the given QoS flow. It is up to 5GC to apply the “mask-and-match configuration.”

In one embodiment, it is specified that when a TSN QoS flow cannot be set up, the NG-RAN node indicates to 5GC that the TSN QoS flow is setup in RAN as a normal QoS flow (i.e. using the UP tunnel for the PDU session). The 5GC should remove the UP UL TNL information and use the UP UL tunnel for the PDU session for the given QoS flow. It is up to 5GC to apply the “mask-and-match configuration.” This is illustrated in Table 4.

TABLE 4
PDU Session Resource Setup Response Transfer
9.3.4.2 PDU Session Resource Setup Response Transfer

| | | | | | | |
|---|---|---|---|---|---|---|
| IE/Group | | | IE type and | Semantics | | Assigned |
| Name | Presence | Range | reference | description | Criticality | Criticality |

| | | | | |
|---|---|---|---|---|
| DL QoS | M | QoS Flow per | NG-RAN | — |
| Flow per | | TNL | node | |
| TNL | | Information | endpoint of | |
| Information | | 9.3.2.8 | the NG-U | |
| | | | transport | |
| | | | bearer for | |
| | | | delivery of | |
| | | | DL PDUs, | |
| | | | together | |
| | | | with | |
| | | | associated | |
| | | | QoS flows. | |

Skip the unrelated

| | | | | | | |
|---|---|---|---|---|---|---|
| MBS | O | | 9.3.1.214 | | YES | ignore |
| Session | | | | | | |
| Failed to | | | | | | |
| Setup List | | | | | | |
| Time | | 0 | | | YES | reject |
| sensitive | | | | | | |
| QoS flow | | | | | | |
| Setup | | | | | | |
| Response | | | | | | |
| List | | | | | | |
| >QoS | | 1 . . . | | | — | |
| Flow | | <maxnoofQoSFlows> | | | | |
| Setup | | | | | | |
| Response | | | | | | |
| Item | | | | | | |
| >>QoS | M | | 9.3.1.51 | | — | |
| Flow | | | | | | |
| Identifier | | | | | | |
| >>NG-U | O | | 9.3.1.12 | | — | |
| DL TNL | | | | | | |
| Information | | | | | | |
| >>NG-U | O | | ENUMERATED | If this IE is | — | |
| DL TNL | | | (true, . . .) | present, the | | |
| not | | | | QoS flow is | | |
| available | | | | setup and | | |
| | | | | use the NG-U | | |
| | | | | tunnel for | | |
| | | | | the PDU | | |
| | | | | session | | |

In Table 4, an NG-RAN node indicates that the “TSN QoS flow” is set up as a normal QoS flow in RAN. It is up to 5GC to determine if TSN “mask-and-match configuration” should be used. If the “NG-U DL TNL not available” IE is included, 5GC shall remove the UP UL TNL for the given QoS flow. The QoS flow is setup as a normal QoS in NG-RAN without individual TNL.

In one embodiment, it is specified that when a PDU session contains only one QoS flow, and the QoS flow is TSN, the UP UL TNL information is the same as for the QoS flow. When more normal QoS flows are added to the PDU session, a new UP UL TNL information for the PDU session is set up.

Thus the set-request in the TL container does not need to be updated.

Alternatively, the TSN QoS flow may be moved to a new tunnel and the set-request may be updated with the InterfaceConfiguration and the QFI tunnel association.

In one embodiment, when Dual Connectivity is deployed, for the PDU session and QoS flow terminated at SN (i.e. the NG-U is connected to SN), the TL Container information should be transferred from master node (MN) to the secondary node (SN), via XnAP protocol signaling. The SN should transfer the response back to the MN, which in turn sends the response back to 5GC. The TL container transfer procedure could be a non-UE associated new procedure, or modify the existing procedure, or using a UE associated procedure.

In one embodiment, in Dual connectivity, the TL Container is sent to the NG-RAN node that terminates the TSN QoS NG-U tunnel. The NG-RAN node is specified not to perform split bearer.

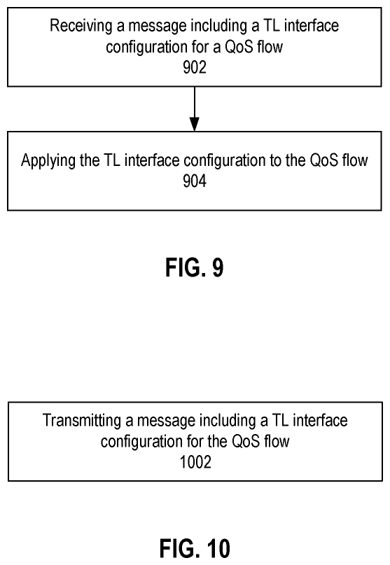

Referring to FIG. 9, some embodiments provide a method performed by a radio access network node. The method includes receiving (block 902), from a network function in a core network, a message including a TL interface configuration for a QoS flow over a transport network between the radio access network node and the core network, and applying (block 904) the TL interface configuration to the QoS flow.

The message may include a TL container transfer message that includes a TL container. In some embodiments, the message includes a TL set-request or a TL get-request.

In response to the message, the QoS flow may be set up or modified to be a TSN QoS flow having an individual TNL IP tunnel.

The method may further include transmitting a TL container response to the network function in response to the message. The TL container response may include a TL set-response or a TL get-response.

The TSN QoS flow may have an associated QFI and the TNL tunnel may be associated with the QFI. The message may include a QFI associated with the TL interface configuration.

The method may further include determining a failure of applying the TL interface configuration to the QoS flow, and in response to the failure of applying the TL interface configuration to the QoS flow, setting up the QoS flow as a normal, non-time sensitive networking, QoS flow.

The message may be a PDU session setup request or a PDU session modification request.

The method may further include receiving a PDU session setup request identifying the QoS flow, and establishing a PDU session for the QoS flow in response to the PDU session setup request, wherein the message including the TL configuration is received after establishment of the PDU session.

Referring to FIG. 10, some embodiments provide a method performed by a network function in a core network. The method includes transmitting (block 1002), to a RAN node, a message including a TL interface configuration for a QoS flow over a transport network between the radio access network node and the core network.

The message may include a TL container transfer message that includes a TL container. In some embodiments, message may include a TL set-request.

The message may indicate that the QoS flow is to be set up or modified to be a TSN QoS flow having an individual TNL IP tunnel.

The TSN QoS flow may have an associated QFI, and the TNL tunnel may be associated with the QFI.

The message may include a QFI associated with the TL interface configuration.

The method may further include receiving from the radio access network node an indication of failure of the radio access network node to set up or modify the QoS flow in response to the message.

The message may include a PDU session setup request.

The method may further include transmitting a PDU session setup request to the radio access network node identifying the QoS flow, and establishing a PDU session for the QoS flow in response to the PDU session setup request, wherein the message including the TL configuration is transmitted after establishment of the PDU session.

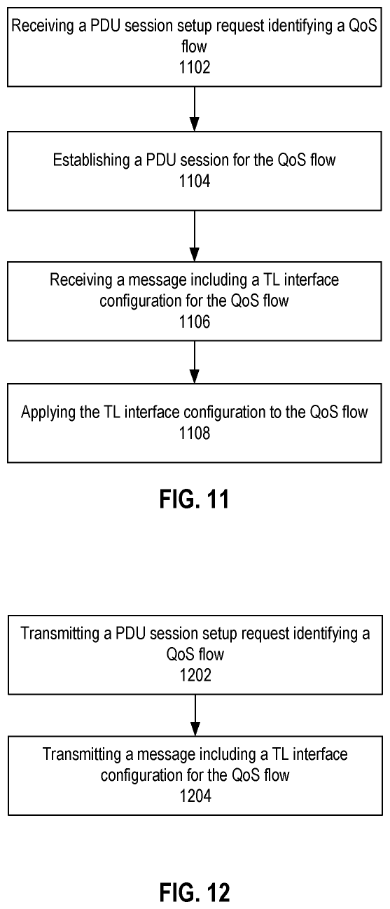

Referring to FIG. 11, some embodiments provide a method performed by a radio access network node. The method includes receiving (block 1102), from a network function in a core network, a PDU session setup request identifying a QoS flow over a transport network between the radio access network node and the core network, establishing (block 1104) a PDU session for the QoS flow in response to the PDU session setup request, receiving (block 1106), from the network function, a message including a TL interface configuration for the QoS flow, and applying (block 1108) the TL interface configuration to the QoS flow.

The message including the TL configuration may be received after establishment of the PDU session.

The method may further include transmitting a TL container response to the network function in response to the message.

The TL container response may include a TL set-response or a TL get-response.

The method may further include providing user data and forwarding the user data to a host using the QoS flow.

Referring to FIG. 12, some embodiments provide a method performed by a network function of a core network. The method includes transmitting (block 1202), to a RAN node, a PDU session setup request identifying a QoS flow over a transport network between the radio access network node and the core network, and upon establishment of a PDU session for the QoS flow in response to the PDU session setup request, transmitting (block 1204), to the RAN node, a message including a TL interface configuration for the QoS flow.

The message may include a TL container transfer message that includes a TL container. In some embodiments, the message may include a TL set-request.

The message may indicate that the QoS flow is to be set up or modified to be a TSN QoS flow having an individual TNL IP tunnel.

The TSN QoS flow may have an associated QFI, and the TNL tunnel may be associated with the QFI.

The message may include a QFI associated with the TL interface configuration.

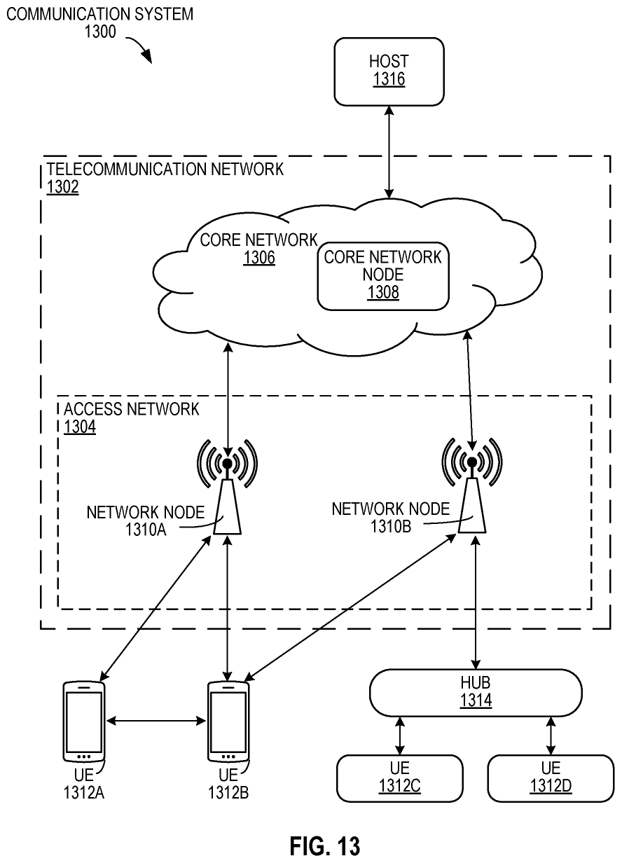

FIG. 13 shows an example of a communication system 1300 in accordance with some embodiments.

In the example, the communication system 1300 includes a telecommunication network 1302 that includes an access network 1304, such as a radio access network (RAN), and a core network 1306, which includes one or more core network nodes 1308. The access network 1304 includes one or more access network nodes, such as network nodes 1310a and 1310b (one or more of which may be generally referred to as network nodes 1310), or any other similar 3^{rd} Generation Partnership Project (3GPP) access nodes or non-3GPP access points. Moreover, as will be appreciated by those of skill in the art, a network node is not necessarily limited to an implementation in which a radio portion and a baseband portion are supplied and integrated by a single vendor. Thus, it will be understood that network nodes include disaggregated implementations or portions thereof. For example, in some embodiments, the telecommunication network 1302 includes one or more Open-RAN (ORAN) network nodes. An ORAN network node is a node in the telecommunication network 1302 that supports an ORAN specification (e.g., a specification published by the O-RAN Alliance, or any similar organization) and may operate alone or together with other nodes to implement one or more functionalities of any node in the telecommunication network 1302, including one or more network nodes 1310 and/or core network nodes 1308.

Examples of an ORAN network node include an open radio unit (O-RU), an open distributed unit (O-DU), an open central unit (O-CU), including an O-CU control plane (O-CU-CP) or an O-CU user plane (O-CU-UP), a RAN intelligent controller (near-real time or non-real time) hosting software or software plug-ins, such as a near-real time control application (e.g., xApp) or a non-real time control application (e.g., rApp), or any combination thereof (the adjective “open” designating support of an ORAN specification). The network node may support a specification by, for example, supporting an interface defined by the ORAN specification, such as an A1, F1, W1, E1, E2, X2, Xn interface, an open fronthaul user plane interface, or an open fronthaul management plane interface. Moreover, an ORAN access node may be a logical node in a physical node. Furthermore, an ORAN network node may be implemented in a virtualization environment (described further below) in which one or more network functions are virtualized. For example, the virtualization environment may include an O-Cloud computing platform orchestrated by a Service Management and Orchestration Framework via an O-2 interface defined by the O-RAN Alliance or comparable technologies. The network nodes 1310 facilitate direct or indirect connection of user equipment (UE), such as by connecting UEs 1312a, 1312b, 1312c, and 1312d (one or more of which may be generally referred to as UEs 1312) to the core network 1306 over one or more wireless connections.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system 1300 may include any number of wired or wireless networks, network nodes, UEs, and/or any other components or systems that may facilitate or participate in the communication of data and/or signals whether via wired or wireless connections. The communication system 1300 may include and/or interface with any type of communication, telecommunication, data, cellular, radio network, and/or other similar type of system.

The UEs 1312 may be any of a wide variety of communication devices, including wireless devices arranged, configured, and/or operable to communicate wirelessly with the network nodes 1310 and other communication devices. Similarly, the network nodes 1310 are arranged, capable, configured, and/or operable to communicate directly or indirectly with the UEs 1312 and/or with other network nodes or equipment in the telecommunication network 1302 to enable and/or provide network access, such as wireless network access, and/or to perform other functions, such as administration in the telecommunication network 1302.

In the depicted example, the core network 1306 connects the network nodes 1310 to one or more hosts, such as host 1316. These connections may be direct or indirect via one or more intermediary networks or devices. In other examples, network nodes may be directly coupled to hosts. The core network 1306 includes one more core network nodes (e.g., core network node 1308) that are structured with hardware and software components. Features of these components may be substantially similar to those described with respect to the UEs, network nodes, and/or hosts, such that the descriptions thereof are generally applicable to the corresponding components of the core network node 1308. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-concealing function (SIDF), Unified Data Management (UDM), Security Edge Protection Proxy (SEPP), Network Exposure Function (NEF), and/or a User Plane Function (UPF).

The host 1316 may be under the ownership or control of a service provider other than an operator or provider of the access network 1304 and/or the telecommunication network 1302, and may be operated by the service provider or on behalf of the service provider. The host 1316 may host a variety of applications to provide one or more service. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, the communication system 1300 of FIG. 13 enables connectivity between the UEs, network nodes, and hosts. In that sense, the communication system may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable 2G, 3G, 4G, 5G standards, or any applicable future generation standard (e.g., 6G); wireless local area network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any low-power wide-area network (LPWAN) standards such as LoRa and Sigfox.

In some examples, the telecommunication network 1302 is a cellular network that implements 3GPP standardized features. Accordingly, the telecommunications network 1302 may support network slicing to provide different logical networks to different devices that are connected to the telecommunication network 1302. For example, the telecommunications network 1302 may provide Ultra Reliable Low Latency Communication (URLLC) services to some UEs, while providing Enhanced Mobile Broadband (eMBB) services to other UEs, and/or Massive Machine Type Communication (mMTC)/Massive IoT services to yet further UEs.

In some examples, the UEs 1312 are configured to transmit and/or receive information without direct human interaction. For instance, a UE may be designed to transmit information to the access network 1304 on a predetermined schedule, when triggered by an internal or external event, or in response to requests from the access network 1304. Additionally, a UE may be configured for operating in single- or multi-RAT or multi-standard mode. For example, a UE may operate with any one or combination of Wi-Fi, NR (New Radio) and LTE, i.e. being configured for multi-radio dual connectivity (MR-DC), such as E-UTRAN (Evolved-UMTS Terrestrial Radio Access Network) New Radio-Dual Connectivity (EN-DC).

In the example, the hub 1314 communicates with the access network 1304 to facilitate indirect communication between one or more UEs (e.g., UE 1312c and/or 1312d) and network nodes (e.g., network node 1310b). In some examples, the hub 1314 may be a controller, router, content source and analytics, or any of the other communication devices described herein regarding UEs. For example, the hub 1314 may be a broadband router enabling access to the core network 1306 for the UEs. As another example, the hub 1314 may be a controller that sends commands or instructions to one or more actuators in the UEs. Commands or instructions may be received from the UEs, network nodes 1310, or by executable code, script, process, or other instructions in the hub 1314. As another example, the hub 1314 may be a data collector that acts as temporary storage for UE data and, in some embodiments, may perform analysis or other processing of the data. As another example, the hub 1314 may be a content source. For example, for a UE that is a VR headset, display, loudspeaker or other media delivery device, the hub 1314 may retrieve VR assets, video, audio, or other media or data related to sensory information via a network node, which the hub 1314 then provides to the UE either directly, after performing local processing, and/or after adding additional local content. In still another example, the hub 1314 acts as a proxy server or orchestrator for the UEs, in particular if one or more of the UEs are low energy IoT devices.

The hub 1314 may have a constant/persistent or intermittent connection to the network node 1310b. The hub 1314 may also allow for a different communication scheme and/or schedule between the hub 1314 and UEs (e.g., UE 1312c and/or 1312d), and between the hub 1314 and the core network 1306. In other examples, the hub 1314 is connected to the core network 1306 and/or one or more UEs via a wired connection. Moreover, the hub 1314 may be configured to connect to an M2M service provider over the access network 1304 and/or to another UE over a direct connection. In some scenarios, UEs may establish a wireless connection with the network nodes 1310 while still connected via the hub 1314 via a wired or wireless connection. In some embodiments, the hub 1314 may be a dedicated hub—that is, a hub whose primary function is to route communications to/from the UEs from/to the network node 1310b. In other embodiments, the hub 1314 may be a non-dedicated hub—that is, a device which is capable of operating to route communications between the UEs and network node 1310b, but which is additionally capable of operating as a communication start and/or end point for certain data channels.

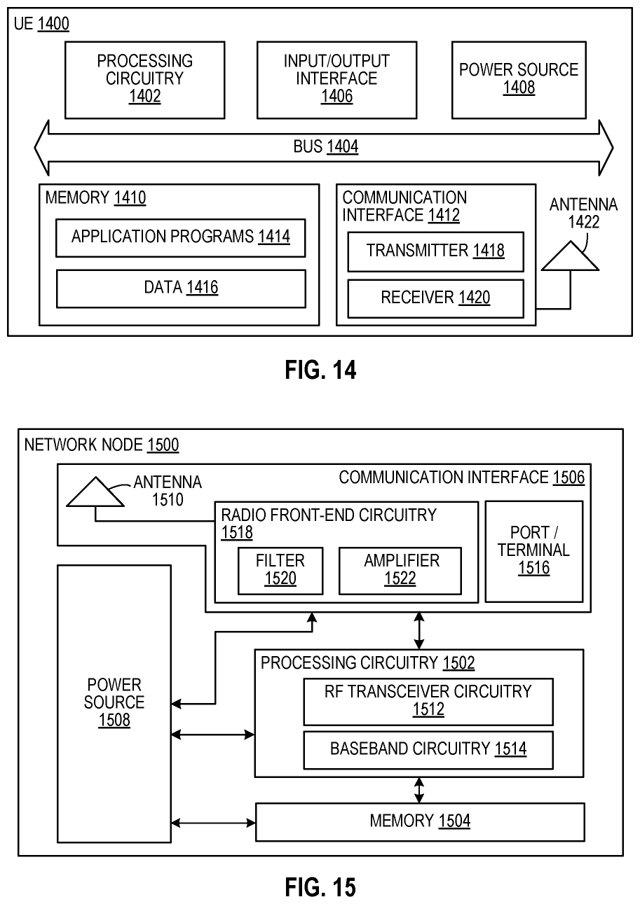

FIG. 14 shows a UE 1400 in accordance with some embodiments. As used herein, a UE refers to a device capable, configured, arranged and/or operable to communicate wirelessly with network nodes and/or other UEs. Examples of a UE include, but are not limited to, a smart phone, mobile phone, cell phone, voice over IP (VoIP) phone, wireless local loop phone, desktop computer, personal digital assistant (PDA), wireless cameras, gaming console or device, music storage device, playback appliance, wearable terminal device, wireless endpoint, mobile station, tablet, laptop, laptop-embedded equipment (LEE), laptop-mounted equipment (LME), smart device, wireless customer-premise equipment (CPE), vehicle, vehicle-mounted or vehicle embedded/integrated wireless device, etc. Other examples include any UE identified by the 3rd Generation Partnership Project (3GPP), including a narrow band internet of things (NB-IoT) UE, a machine type communication (MTC) UE, and/or an enhanced MTC (eMTC) UE.

A UE may support device-to-device (D2D) communication, for example by implementing a 3GPP standard for sidelink communication, Dedicated Short-Range Communication (DSRC), vehicle-to-vehicle (V2V), vehicle-to-infrastructure (V2I), or vehicle-to-everything (V2X). In other examples, a UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter).

The UE 1400 includes processing circuitry 1402 that is operatively coupled via a bus 1404 to an input/output interface 1406, a power source 1408, a memory 1410, a communication interface 1412, and/or any other component, or any combination thereof. Certain UEs may utilize all or a subset of the components shown in FIG. 14. The level of integration between the components may vary from one UE to another UE. Further, certain UEs may contain multiple instances of a component, such as multiple processors, memories, transceivers, transmitters, receivers, etc.

The processing circuitry 1402 is configured to process instructions and data and may be configured to implement any sequential state machine operative to execute instructions stored as machine-readable computer programs in the memory 1410. The processing circuitry 1402 may be implemented as one or more hardware-implemented state machines (e.g., in discrete logic, field-programmable gate arrays (FPGAs), application specific integrated circuits (ASICs), etc.); programmable logic together with appropriate firmware; one or more stored computer programs, general-purpose processors, such as a microprocessor or digital signal processor (DSP), together with appropriate software; or any combination of the above. For example, the processing circuitry 1402 may include multiple central processing units (CPUs).

In the example, the input/output interface 1406 may be configured to provide an interface or interfaces to an input device, output device, or one or more input and/or output devices. Examples of an output device include a speaker, a sound card, a video card, a display, a monitor, a printer, an actuator, an emitter, a smartcard, another output device, or any combination thereof. An input device may allow a user to capture information into the UE 1400. Examples of an input device include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, a biometric sensor, etc., or any combination thereof. An output device may use the same type of interface port as an input device. For example, a Universal Serial Bus (USB) port may be used to provide an input device and an output device.

In some embodiments, the power source 1408 is structured as a battery or battery pack. Other types of power sources, such as an external power source (e.g., an electricity outlet), photovoltaic device, or power cell, may be used. The power source 1408 may further include power circuitry for delivering power from the power source 1408 itself, and/or an external power source, to the various parts of the UE 1400 via input circuitry or an interface such as an electrical power cable. Delivering power may be, for example, for charging of the power source 1408. Power circuitry may perform any formatting, converting, or other modification to the power from the power source 1408 to make the power suitable for the respective components of the UE 1400 to which power is supplied.

The memory 1410 may be or be configured to include memory such as random access memory (RAM), read-only memory (ROM), programmable read-only memory (PROM), erasable programmable read-only memory (EPROM), electrically erasable programmable read-only memory (EEPROM), magnetic disks, optical disks, hard disks, removable cartridges, flash drives, and so forth. In one example, the memory 1410 includes one or more application programs 1414, such as an operating system, web browser application, a widget, gadget engine, or other application, and corresponding data 1416. The memory 1410 may store, for use by the UE 1400, any of a variety of various operating systems or combinations of operating systems.

The memory 1410 may be configured to include a number of physical drive units, such as redundant array of independent disks (RAID), flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as tamper resistant module in the form of a universal integrated circuit card (UICC) including one or more subscriber identity modules (SIMs), such as a USIM and/or ISIM, other memory, or any combination thereof. The UICC may for example be an embedded UICC (eUICC), integrated UICC (iUICC) or a removable UICC commonly known as ‘SIM card.’ The memory 1410 may allow the UE 1400 to access instructions, application programs and the like, stored on transitory or non-transitory memory media, to off-load data, or to upload data. An article of manufacture, such as one utilizing a communication system may be tangibly embodied as or in the memory 1410, which may be or comprise a device-readable storage medium.

The processing circuitry 1402 may be configured to communicate with an access network or other network using the communication interface 1412. The communication interface 1412 may comprise one or more communication subsystems and may include or be communicatively coupled to an antenna 1422. The communication interface 1412 may include one or more transceivers used to communicate, such as by communicating with one or more remote transceivers of another device capable of wireless communication (e.g., another UE or a network node in an access network). Each transceiver may include a transmitter 1418 and/or a receiver 1420 appropriate to provide network communications (e.g., optical, electrical, frequency allocations, and so forth). Moreover, the transmitter 1418 and receiver 1420 may be coupled to one or more antennas (e.g., antenna 1422) and may share circuit components, software or firmware, or alternatively be implemented separately.

In the illustrated embodiment, communication functions of the communication interface 1412 may include cellular communication, Wi-Fi communication, LPWAN communication, data communication, voice communication, multimedia communication, short-range communications such as Bluetooth, near-field communication, location-based communication such as the use of the global positioning system (GPS) to determine a location, another like communication function, or any combination thereof. Communications may be implemented in according to one or more communication protocols and/or standards, such as IEEE 802.11, Code Division Multiplexing Access (CDMA), Wideband Code Division Multiple Access (WCDMA), GSM, LTE, New Radio (NR), UMTS, WiMax, Ethernet, transmission control protocol/internet protocol (TCP/IP), synchronous optical networking (SONET), Asynchronous Transfer Mode (ATM), QUIC, Hypertext Transfer Protocol (HTTP), and so forth.

Regardless of the type of sensor, a UE may provide an output of data captured by its sensors, through its communication interface 1412, via a wireless connection to a network node. Data captured by sensors of a UE can be communicated through a wireless connection to a network node via another UE. The output may be periodic (e.g., once every 15 minutes if it reports the sensed temperature), random (e.g., to even out the load from reporting from several sensors), in response to a triggering event (e.g., when moisture is detected an alert is sent), in response to a request (e.g., a user initiated request), or a continuous stream (e.g., a live video feed of a patient).

As another example, a UE comprises an actuator, a motor, or a switch, related to a communication interface configured to receive wireless input from a network node via a wireless connection. In response to the received wireless input the states of the actuator, the motor, or the switch may change. For example, the UE may comprise a motor that adjusts the control surfaces or rotors of a drone in flight according to the received input or to a robotic arm performing a medical procedure according to the received input.

A UE, when in the form of an Internet of Things (IoT) device, may be a device for use in one or more application domains, these domains comprising, but not limited to, city wearable technology, extended industrial application and healthcare. Non-limiting examples of such an IoT device are a device which is or which is embedded in: a connected refrigerator or freezer, a TV, a connected lighting device, an electricity meter, a robot vacuum cleaner, a voice controlled smart speaker, a home security camera, a motion detector, a thermostat, a smoke detector, a door/window sensor, a flood/moisture sensor, an electrical door lock, a connected doorbell, an air conditioning system like a heat pump, an autonomous vehicle, a surveillance system, a weather monitoring device, a vehicle parking monitoring device, an electric vehicle charging station, a smart watch, a fitness tracker, a head-mounted display for Augmented Reality (AR) or Virtual Reality (VR), a wearable for tactile augmentation or sensory enhancement, a water sprinkler, an animal- or item-tracking device, a sensor for monitoring a plant or animal, an industrial robot, an Unmanned Aerial Vehicle (UAV), and any kind of medical device, like a heart rate monitor or a remote controlled surgical robot. A UE in the form of an IoT device comprises circuitry and/or software in dependence of the intended application of the IoT device in addition to other components as described in relation to the UE 1400 shown in FIG. 14.

As yet another specific example, in an IoT scenario, a UE may represent a machine or other device that performs monitoring and/or measurements, and transmits the results of such monitoring and/or measurements to another UE and/or a network node. The UE may in this case be an M2M device, which may in a 3GPP context be referred to as an MTC device. As one particular example, the UE may implement the 3GPP NB-IoT standard. In other scenarios, a UE may represent a vehicle, such as a car, a bus, a truck, a ship and an airplane, or other equipment that is capable of monitoring and/or reporting on its operational status or other functions associated with its operation.

In practice, any number of UEs may be used together with respect to a single use case. For example, a first UE might be or be integrated in a drone and provide the drone's speed information (obtained through a speed sensor) to a second UE that is a remote controller operating the drone. When the user makes changes from the remote controller, the first UE may adjust the throttle on the drone (e.g. by controlling an actuator) to increase or decrease the drone's speed. The first and/or the second UE can also include more than one of the functionalities described above. For example, a UE might comprise the sensor and the actuator, and handle communication of data for both the speed sensor and the actuators.

FIG. 15 shows a network node 1500 in accordance with some embodiments. As used herein, network node refers to equipment capable, configured, arranged and/or operable to communicate directly or indirectly with a UE and/or with other network nodes or equipment, in a telecommunication network. Examples of network nodes include, but are not limited to, access points (APs) (e.g., radio access points), base stations (BSs) (e.g., radio base stations, Node Bs, evolved Node Bs (eNBs) and NR NodeBs (gNBs)), O-RAN nodes or components of an O-RAN node (e.g., O-RU, O-DU, O-CU).

Base stations may be categorized based on the amount of coverage they provide (or, stated differently, their transmit power level) and so, depending on the provided amount of coverage, may be referred to as femto base stations, pico base stations, micro base stations, or macro base stations. A base station may be a relay node or a relay donor node controlling a relay. A network node may also include one or more (or all) parts of a distributed radio base station such as centralized digital units, distributed units (e.g., in an O-RAN access node) and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS).

Other examples of network nodes include multiple transmission point (multi-TRP) 5G access nodes, multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), Operation and Maintenance (O&M) nodes, Operations Support System (OSS) nodes, Self-Organizing Network (SON) nodes, positioning nodes (e.g., Evolved Serving Mobile Location Centers (E-SMLCs)), and/or Minimization of Drive Tests (MDTs).

The network node 1500 includes a processing circuitry 1502, a memory 1504, a communication interface 1506, and a power source 1508. The network node 1500 may be composed of multiple physically separate components (e.g., a NodeB component and a RNC component, or a BTS component and a BSC component, etc.), which may each have their own respective components. In certain scenarios in which the network node 1500 comprises multiple separate components (e.g., BTS and BSC components), one or more of the separate components may be shared among several network nodes. For example, a single RNC may control multiple NodeBs. In such a scenario, each unique NodeB and RNC pair, may in some instances be considered a single separate network node. In some embodiments, the network node 1500 may be configured to support multiple radio access technologies (RATs). In such embodiments, some components may be duplicated (e.g., separate memory 1504 for different RATs) and some components may be reused (e.g., a same antenna 1510 may be shared by different RATs). The network node 1500 may also include multiple sets of the various illustrated components for different wireless technologies integrated into network node 1500, for example GSM, WCDMA, LTE, NR, WiFi, Zigbee, Z-wave, LoRaWAN, Radio Frequency Identification (RFID) or Bluetooth wireless technologies. These wireless technologies may be integrated into the same or different chip or set of chips and other components within network node 1500.

The processing circuitry 1502 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 1500 components, such as the memory 1504, to provide network node 1500 functionality.

In some embodiments, the processing circuitry 1502 includes a system on a chip (SOC). In some embodiments, the processing circuitry 1502 includes one or more of radio frequency (RF) transceiver circuitry 1512 and baseband processing circuitry 1514. In some embodiments, the radio frequency (RF) transceiver circuitry 1512 and the baseband processing circuitry 1514 may be on separate chips (or sets of chips), boards, or units, such as radio units and digital units. In alternative embodiments, part or all of RF transceiver circuitry 1512 and baseband processing circuitry 1514 may be on the same chip or set of chips, boards, or units.

The memory 1504 may comprise any form of volatile or non-volatile computer-readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device-readable and/or computer-executable memory devices that store information, data, and/or instructions that may be used by the processing circuitry 1502. The memory 1504 may store any suitable instructions, data, or information, including a computer program, software, an application including one or more of logic, rules, code, tables, and/or other instructions capable of being executed by the processing circuitry 1502 and utilized by the network node 1500. The memory 1504 may be used to store any calculations made by the processing circuitry 1502 and/or any data received via the communication interface 1506. In some embodiments, the processing circuitry 1502 and memory 1504 is integrated.

The communication interface 1506 is used in wired or wireless communication of signaling and/or data between a network node, access network, and/or UE. As illustrated, the communication interface 1506 comprises port(s)/terminal(s) 1516 to send and receive data, for example to and from a network over a wired connection. The communication interface 1506 also includes radio front-end circuitry 1518 that may be coupled to, or in certain embodiments a part of, the antenna 1510. Radio front-end circuitry 1518 comprises filters 1520 and amplifiers 1522. The radio front-end circuitry 1518 may be connected to an antenna 1510 and processing circuitry 1502. The radio front-end circuitry may be configured to condition signals communicated between antenna 1510 and processing circuitry 1502. The radio front-end circuitry 1518 may receive digital data that is to be sent out to other network nodes or UEs via a wireless connection. The radio front-end circuitry 1518 may convert the digital data into a radio signal having the appropriate channel and bandwidth parameters using a combination of filters 1520 and/or amplifiers 1522. The radio signal may then be transmitted via the antenna 1510. Similarly, when receiving data, the antenna 1510 may collect radio signals which are then converted into digital data by the radio front-end circuitry 1518. The digital data may be passed to the processing circuitry 1502. In other embodiments, the communication interface may comprise different components and/or different combinations of components.

In certain alternative embodiments, the network node 1500 does not include separate radio front-end circuitry 1518, instead, the processing circuitry 1502 includes radio front-end circuitry and is connected to the antenna 1510. Similarly, in some embodiments, all or some of the RF transceiver circuitry 1512 is part of the communication interface 1506. In still other embodiments, the communication interface 1506 includes one or more ports or terminals 1516, the radio front-end circuitry 1518, and the RF transceiver circuitry 1512, as part of a radio unit (not shown), and the communication interface 1506 communicates with the baseband processing circuitry 1514, which is part of a digital unit (not shown).

The antenna 1510 may include one or more antennas, or antenna arrays, configured to send and/or receive wireless signals. The antenna 1510 may be coupled to the radio front-end circuitry 1518 and may be any type of antenna capable of transmitting and receiving data and/or signals wirelessly. In certain embodiments, the antenna 1510 is separate from the network node 1500 and connectable to the network node 1500 through an interface or port.

The antenna 1510, communication interface 1506, and/or the processing circuitry 1502 may be configured to perform any receiving operations and/or certain obtaining operations described herein as being performed by the network node. Any information, data and/or signals may be received from a UE, another network node and/or any other network equipment. Similarly, the antenna 1510, the communication interface 1506, and/or the processing circuitry 1502 may be configured to perform any transmitting operations described herein as being performed by the network node. Any information, data and/or signals may be transmitted to a UE, another network node and/or any other network equipment.

The power source 1508 provides power to the various components of network node 1500 in a form suitable for the respective components (e.g., at a voltage and current level needed for each respective component). The power source 1508 may further comprise, or be coupled to, power management circuitry to supply the components of the network node 1500 with power for performing the functionality described herein. For example, the network node 1500 may be connectable to an external power source (e.g., the power grid, an electricity outlet) via an input circuitry or interface such as an electrical cable, whereby the external power source supplies power to power circuitry of the power source 1508. As a further example, the power source 1508 may comprise a source of power in the form of a battery or battery pack which is connected to, or integrated in, power circuitry. The battery may provide backup power should the external power source fail.

Embodiments of the network node 1500 may include additional components beyond those shown in FIG. 15 for providing certain aspects of the network node's functionality, including any of the functionality described herein and/or any functionality necessary to support the subject matter described herein. For example, the network node 1500 may include user interface equipment to allow input of information into the network node 1500 and to allow output of information from the network node 1500. This may allow a user to perform diagnostic, maintenance, repair, and other administrative functions for the network node 1500.

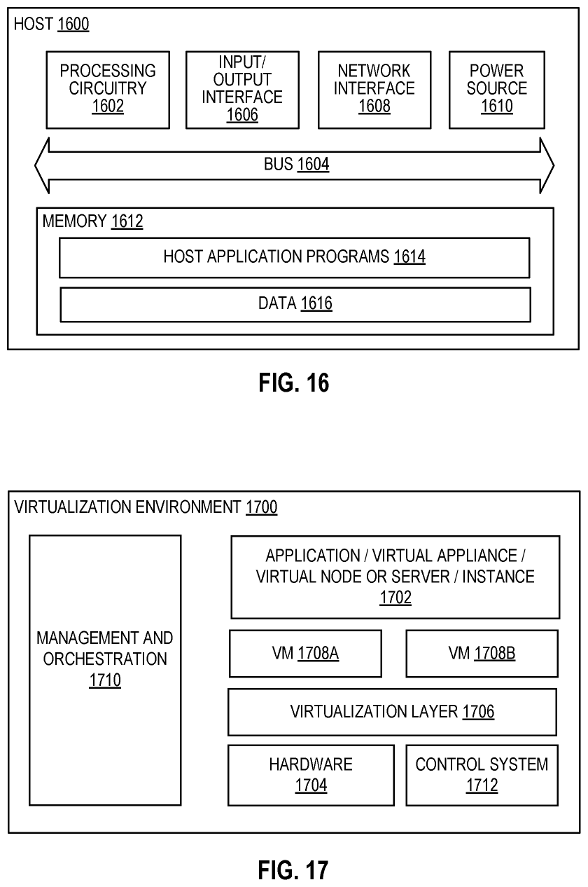

FIG. 16 is a block diagram of a host 1600, which may be an embodiment of the host 1316 of FIG. 13, in accordance with various aspects described herein. As used herein, the host 1600 may be or comprise various combinations hardware and/or software, including a standalone server, a blade server, a cloud-implemented server, a distributed server, a virtual machine, container, or processing resources in a server farm. The host 1600 may provide one or more services to one or more UEs.

The host 1600 includes processing circuitry 1602 that is operatively coupled via a bus 1604 to an input/output interface 1606, a network interface 1608, a power source 1610, and a memory 1612. Other components may be included in other embodiments. Features of these components may be substantially similar to those described with respect to the devices of previous figures, such as FIGS. 14 and 15, such that the descriptions thereof are generally applicable to the corresponding components of host 1600.

The memory 1612 may include one or more computer programs including one or more host application programs 1614 and data 1616, which may include user data, e.g., data generated by a UE for the host 1600 or data generated by the host 1600 for a UE. Embodiments of the host 1600 may utilize only a subset or all of the components shown. The host application programs 1614 may be implemented in a container-based architecture and may provide support for video codecs (e.g., Versatile Video Coding (VVC), High Efficiency Video Coding (HEVC), Advanced Video Coding (AVC), MPEG, VP9) and audio codecs (e.g., FLAC, Advanced Audio Coding (AAC), MPEG, G.711), including transcoding for multiple different classes, types, or implementations of UEs (e.g., handsets, desktop computers, wearable display systems, heads-up display systems). The host application programs 1614 may also provide for user authentication and licensing checks and may periodically report health, routes, and content availability to a central node, such as a device in or on the edge of a core network. Accordingly, the host 1600 may select and/or indicate a different host for over-the-top services for a UE. The host application programs 1614 may support various protocols, such as the HTTP Live Streaming (HLS) protocol, Real-Time Messaging Protocol (RTMP), Real-Time Streaming Protocol (RTSP), Dynamic Adaptive Streaming over HTTP (MPEG-DASH), etc.

FIG. 17 is a block diagram illustrating a virtualization environment 1700 in which functions implemented by some embodiments may be virtualized. In the present context, virtualizing means creating virtual versions of apparatuses or devices which may include virtualizing hardware platforms, storage devices and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more virtual machines (VMs) implemented in one or more virtual environments 1700 hosted by one or more of hardware nodes, such as a hardware computing device that operates as a network node, UE, core network node, or host. Further, in embodiments in which the virtual node does not require radio connectivity (e.g., a core network node or host), then the node may be entirely virtualized. In some embodiments, the virtualization environment 1700 includes components defined by the O-RAN Alliance, such as an O-Cloud environment orchestrated by a Service Management and Orchestration Framework via an O-2 interface.

Applications 1702 (which may alternatively be called software instances, virtual appliances, network functions, virtual nodes, virtual network functions, etc.) are run in the virtualization environment Q400 to implement some of the features, functions, and/or benefits of some of the embodiments disclosed herein.

Hardware 1704 includes processing circuitry, memory that stores software and/or instructions executable by hardware processing circuitry, and/or other hardware devices as described herein, such as a network interface, input/output interface, and so forth. Software may be executed by the processing circuitry to instantiate one or more virtualization layers 1706 (also referred to as hypervisors or virtual machine monitors (VMMs)), provide VMs 1708a and 1708b (one or more of which may be generally referred to as VMs 1708), and/or perform any of the functions, features and/or benefits described in relation with some embodiments described herein. The virtualization layer 1706 may present a virtual operating platform that appears like networking hardware to the VMs 1708.

The VMs 1708 comprise virtual processing, virtual memory, virtual networking or interface and virtual storage, and may be run by a corresponding virtualization layer 1706. Different embodiments of the instance of a virtual appliance 1702 may be implemented on one or more of VMs 1708, and the implementations may be made in different ways. Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, a VM 1708 may be a software implementation of a physical machine that runs programs as if they were executing on a physical, non-virtualized machine. Each of the VMs 1708, and that part of hardware 1704 that executes that VM, be it hardware dedicated to that VM and/or hardware shared by that VM with others of the VMs, forms separate virtual network elements. Still in the context of NFV, a virtual network function is responsible for handling specific network functions that run in one or more VMs 1708 on top of the hardware 1704 and corresponds to the application 1702.

Hardware 1704 may be implemented in a standalone network node with generic or specific components. Hardware 1704 may implement some functions via virtualization. Alternatively, hardware 1704 may be part of a larger cluster of hardware (e.g. such as in a data center or CPE) where many hardware nodes work together and are managed via management and orchestration 1710, which, among others, oversees lifecycle management of applications 1702. In some embodiments, hardware 1704 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a radio access node or a base station. In some embodiments, some signaling can be provided with the use of a control system 1712 which may alternatively be used for communication between hardware nodes and radio units.

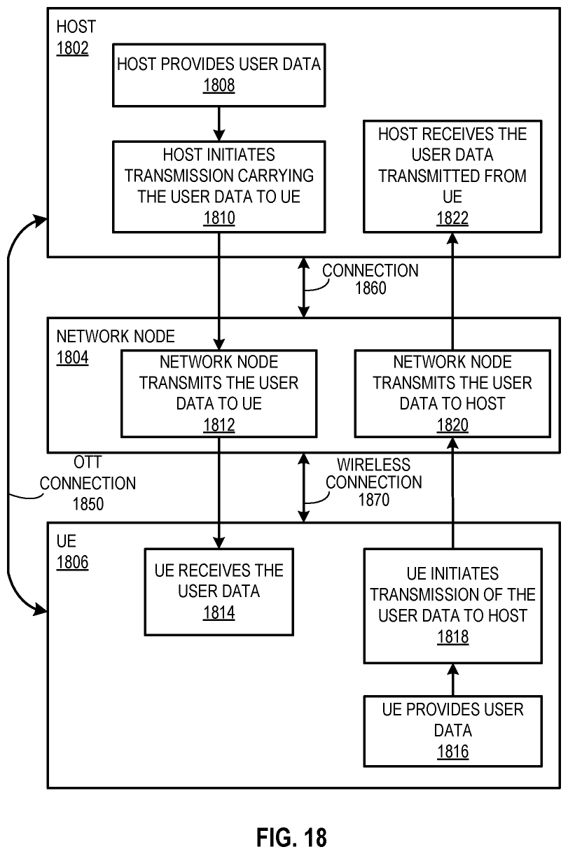

FIG. 18 shows a communication diagram of a host 1802 communicating via a network node 1804 with a UE 1806 over a partially wireless connection in accordance with some embodiments. Example implementations, in accordance with various embodiments, of the UE (such as a UE 1312a of FIG. 13 and/or UE 1400 of FIG. 14), network node (such as network node 1310a of FIG. 13 and/or network node 1500 of FIG. 15), and host (such as host 1316 of FIG. 13 and/or host 1600 of FIG. 16) discussed in the preceding paragraphs will now be described with reference to FIG. 18.

Like host 1600, embodiments of host 1802 include hardware, such as a communication interface, processing circuitry, and memory. The host 1802 also includes software, which is stored in or accessible by the host 1802 and executable by the processing circuitry. The software includes a host application that may be operable to provide a service to a remote user, such as the UE 1806 connecting via an over-the-top (OTT) connection 1850 extending between the UE 1806 and host 1802. In providing the service to the remote user, a host application may provide user data which is transmitted using the OlT connection 1850.

The network node 1804 includes hardware enabling it to communicate with the host 1802 and UE 1806. The connection 1860 may be direct or pass through a core network (like core network 1306 of FIG. 13) and/or one or more other intermediate networks, such as one or more public, private, or hosted networks. For example, an intermediate network may be a backbone network or the Internet.

The UE 1806 includes hardware and software, which is stored in or accessible by UE 1806 and executable by the UE's processing circuitry. The software includes a client application, such as a web browser or operator-specific “app” that may be operable to provide a service to a human or non-human user via UE 1806 with the support of the host 1802. In the host 1802, an executing host application may communicate with the executing client application via the OT connection 1850 terminating at the UE 1806 and host 1802. In providing the service to the user, the UE's client application may receive request data from the host's host application and provide user data in response to the request data. The OTT connection 1850 may transfer both the request data and the user data. The UE's client application may interact with the user to generate the user data that it provides to the host application through the OT connection 1850.

The OT connection 1850 may extend via a connection 1860 between the host 1802 and the network node 1804 and via a wireless connection 1870 between the network node 1804 and the UE 1806 to provide the connection between the host 1802 and the UE 1806. The connection 1860 and wireless connection 1870, over which the OTT connection 1850 may be provided, have been drawn abstractly to illustrate the communication between the host 1802 and the UE 1806 via the network node 1804, without explicit reference to any intermediary devices and the precise routing of messages via these devices.

As an example of transmitting data via the OTT connection 1850, in step 1808, the host 1802 provides user data, which may be performed by executing a host application. In some embodiments, the user data is associated with a particular human user interacting with the UE 1806. In other embodiments, the user data is associated with a UE 1806 that shares data with the host 1802 without explicit human interaction. In step 1810, the host 1802 initiates a transmission carrying the user data towards the UE 1806. The host 1802 may initiate the transmission responsive to a request transmitted by the UE 1806. The request may be caused by human interaction with the UE 1806 or by operation of the client application executing on the UE 1806. The transmission may pass via the network node 1804, in accordance with the teachings of the embodiments described throughout this disclosure. Accordingly, in step 1812, the network node 1804 transmits to the UE 1806 the user data that was carried in the transmission that the host 1802 initiated, in accordance with the teachings of the embodiments described throughout this disclosure. In step 1814, the UE 1806 receives the user data carried in the transmission, which may be performed by a client application executed on the UE 1806 associated with the host application executed by the host 1802.

In some examples, the UE 1806 executes a client application which provides user data to the host 1802. The user data may be provided in reaction or response to the data received from the host 1802. Accordingly, in step 1816, the UE 1806 may provide user data, which may be performed by executing the client application. In providing the user data, the client application may further consider user input received from the user via an input/output interface of the UE 1806. Regardless of the specific manner in which the user data was provided, the UE 1806 initiates, in step 1818, transmission of the user data towards the host 1802 via the network node 1804. In step 1820, in accordance with the teachings of the embodiments described throughout this disclosure, the network node 1804 receives user data from the UE 1806 and initiates transmission of the received user data towards the host 1802. In step 1822, the host 1802 receives the user data carried in the transmission initiated by the UE 1806.

One or more of the various embodiments improve the performance of OTT services provided to the UE 1806 using the OTT connection 1850, in which the wireless connection 1870 forms the last segment.

In an example scenario, factory status information may be collected and analyzed by the host 1802. As another example, the host 1802 may process audio and video data which may have been retrieved from a UE for use in creating maps. As another example, the host 1802 may collect and analyze real-time data to assist in controlling vehicle congestion (e.g., controlling traffic lights). As another example, the host 1802 may store surveillance video uploaded by a UE. As another example, the host 1802 may store or control access to media content such as video, audio, VR or AR which it can broadcast, multicast or unicast to UEs. As other examples, the host 1802 may be used for energy pricing, remote control of non-time critical electrical load to balance power generation needs, location services, presentation services (such as compiling diagrams etc. from data collected from remote devices), or any other function of collecting, retrieving, storing, analyzing and/or transmitting data.

In some examples, a measurement procedure may be provided for the purpose of monitoring data rate, latency and other factors on which the one or more embodiments improve. There may further be an optional network functionality for reconfiguring the OT connection 1850 between the host 1802 and UE 1806, in response to variations in the measurement results. The measurement procedure and/or the network functionality for reconfiguring the OlT connection may be implemented in software and hardware of the host 1802 and/or UE 1806. In some embodiments, sensors (not shown) may be deployed in or in association with other devices through which the OT connection 1850 passes; the sensors may participate in the measurement procedure by supplying values of the monitored quantities exemplified above, or supplying values of other physical quantities from which software may compute or estimate the monitored quantities. The reconfiguring of the OT connection 1850 may include message format, retransmission settings, preferred routing etc.; the reconfiguring need not directly alter the operation of the network node 1804. Such procedures and functionalities may be known and practiced in the art. In certain embodiments, measurements may involve proprietary UE signaling that facilitates measurements of throughput, propagation times, latency and the like, by the host 1802. The measurements may be implemented in that software causes messages to be transmitted, in particular empty or ‘dummy’ messages, using the OTT connection 1850 while monitoring propagation times, errors, etc.

Although the computing devices described herein (e.g., UEs, network nodes, hosts) may include the illustrated combination of hardware components, other embodiments may comprise computing devices with different combinations of components. It is to be understood that these computing devices may comprise any suitable combination of hardware and/or software needed to perform the tasks, features, functions and methods disclosed herein. Determining, calculating, obtaining or similar operations described herein may be performed by processing circuitry, which may process information by, for example, converting the obtained information into other information, comparing the obtained information or converted information to information stored in the network node, and/or performing one or more operations based on the obtained information or converted information, and as a result of said processing making a determination. Moreover, while components are depicted as single boxes located within a larger box, or nested within multiple boxes, in practice, computing devices may comprise multiple different physical components that make up a single illustrated component, and functionality may be partitioned between separate components. For example, a communication interface may be configured to include any of the components described herein, and/or the functionality of the components may be partitioned between the processing circuitry and the communication interface. In another example, non-computationally intensive functions of any of such components may be implemented in software or firmware and computationally intensive functions may be implemented in hardware.

In certain embodiments, some or all of the functionality described herein may be provided by processing circuitry executing instructions stored on in memory, which in certain embodiments may be a computer program product in the form of a non-transitory computer-readable storage medium. In alternative embodiments, some or all of the functionality may be provided by the processing circuitry without executing instructions stored on a separate or discrete device-readable storage medium, such as in a hard-wired manner. In any of those particular embodiments, whether executing instructions stored on a non-transitory computer-readable storage medium or not, the processing circuitry can be configured to perform the described functionality. The benefits provided by such functionality are not limited to the processing circuitry alone or to other components of the computing device, but are enjoyed by the computing device as a whole, and/or by end users and a wireless network generally.

### REFERENCES

[1]3GPP TS 23.501 v18.1.0

1. A method performed by a radio access network node, the method comprising:
receiving, from a network function in a core network, a message including a talker/listener, TL, interface configuration for a quality of service, QoS, flow over a transport network between the radio access network node and the core network; and
applying the TL interface configuration to the QoS flow.

2. The method of claim 1, wherein the message comprises a TL container transfer message that includes a TL container.

3. The method of claim 1, wherein the message comprises a TL set-request or a TL get-request.

4. The method of claim 1, wherein in response to the message, the QoS flow is set up or modified to be a time-sensitive networking, TSN, QoS flow having an individual transport network layer, TNL, internet protocol, IP, tunnel.

5. The method of claim 1, further comprising transmitting a TL container response to the network function in response to the message.

6. The method of claim 5, wherein the TL container response comprises a TL set-response or a TL get-response.

7. The method of claim 5, wherein the TSN QoS flow has an associated QoS flow indicator, QFI, and wherein the TNL tunnel is associated with the QFI.

8. The method of claim 1, wherein the message includes a QoS flow indicator, QFI, associated with the TL interface configuration.

9. The method of claim 1, further comprising:
determining a failure of applying the TL interface configuration to the QoS flow; and
in response to the failure of applying the TL interface configuration to the QoS flow, setting up the QoS flow as a normal, non-time sensitive networking, QoS flow.

10. The method of claim 1, wherein the message comprises a protocol data unit, PDU, session setup request or a PDU session modification request.

11. The method of claim 1, further comprising:
receiving a protocol data unit, PDU, session setup request identifying the QoS flow; and
establishing a PDU session for the QoS flow in response to the PDU session setup request;
wherein the message including the TL configuration is received after establishment of the PDU session.

12. A method performed by a radio access network node, comprising:
receiving, from a network function in a core network, a protocol data unit, PDU, session setup request identifying a quality of service, QoS, flow over a transport network between the radio access network node and the core network;
establishing a PDU session for the QoS flow in response to the PDU session setup request;
receiving, from the network function, a message including a talker/listener, TL, interface configuration for the QoS flow; and
applying the TL interface configuration to the QoS flow.

13. The method of claim 12, wherein the message including the TL configuration is received after establishment of the PDU session.

14. The method of claim 12, further comprising transmitting a TL container response to the network function in response to the message.

15. The method of claim 14, wherein the TL container response comprises a TL set-response or a TL get-response.

16. The method of claim 1, further comprising:
providing user data; and
forwarding the user data to a host using the QoS flow.

17. (canceled)

18. A method performed by a network function in a core network, the method comprising:
transmitting, to a radio access network, RAN, node, a message including a talker/listener, TL, interface configuration for a quality of service, QoS, flow over a transport network between the radio access network node and the core network.

19. The method of claim 18, wherein the message comprises at least one of:
a TL container transfer message that includes a TL container;
a TL set-request;
an indication that the QoS flow is to be set up or modified to be a time-sensitive networking, TSN, QoS flow having an individual transport network layer, TNL, internet protocol, IP, tunnel;
a QoS flow indicator, QFI, associated with the TL interface configuration; and
a protocol data unit, PDU, session setup request.

20-23. (canceled)

24. The method of claim 18, further comprising:
receiving from the radio access network node an indication of failure of the radio access network node to set up or modify the QoS flow in response to the message.

25-26. (canceled)

27. A method performed by a network function of a core network, comprising:
transmitting, to a radio access network, RAN, node, a protocol data unit, PDU, session setup request identifying a quality of service, QoS, flow over a transport network between the radio access network node and the core network; and
upon establishment of a PDU session for the QoS flow in response to the PDU session setup request, transmitting, to the RAN node, a message including a talker/listener, TL, interface configuration for the QoS flow.

28-33. (canceled)
